(19) United States
(12) Patent Application Publication
(10) Pub. No.: US 2010/0189553 A1
(43) Pub. Date: Jul. 29, 2010

(54) TURBO AIR COMPRESSOR SYSTEM

(75) Inventors: Hyung Ju Yoo, Seoul (KR); Sung Kwon Yoo, Seoul (KR)

Correspondence Address: Jefferson IP Law, LLP, 1130 Connecticut Ave., NW, Suite 420, Washington, DC, 20036, US

(73) Assignee: IRWINDPOWER CO., LTD, Seoul (KR)

(21) Appl. No.: 12/439,730

(22) PCT Filed: Sep. 28, 2006
(86) PCT No.: PCT/KR06/03862

§ 371 Date: Mar. 3, 2009

(30) Foreign Application Priority Data
Sep. 5, 2006 (KR) 10-2006-0084946

(51) Int. Cl. F03D 3/04

(52) U.S. Cl. 415/183

(57) ABSTRACT

Provided is a turbo air compressor system which is mounted to a rotor or a blade housing of a wind power system to change a path of an air inflow, compress the flowing air, and increase the rotation speed and the rotating force of a rotating member such as a turbine or a blade. When the turbo air compressor system is mounted to the wind power system having a cylinder-shaped rotor, various applications in which a size of the main body and the multistage structure can be changed according to an external environment can be provided in consideration of a size of the rotor and changes in the wind direction and the wind speed. In addition, the cylinder-shaped rotor additionally including a direct ion change device includes rear surface inclined portions, so that air resistances that occur at the wings of the blade or the rotor or drag against the rotation direction can be minimized.

### TECHNICAL FIELD

The present invention relates to a turbo air compressor system mounted to a system using wind energy. A conventional system using wind energy generally includes a rotor and tail wings and has a structure in which the tail winds operate in the direction of the wind so as to enable air to flow to the rotor. In this structure, a portion of the air flowing to the rotor flows to exert force on the rotor in contrary directions to disturb efficient rotation of the rotor. Therefore, there is a problem in that the system using wind energy cannot practically obtain a high efficiency.

### BACKGROUND ART

A conventional system using windmills has problems of decreases in the rotation efficiency and increases in friction and noise due to increases in resistances against the wind speed in the system. In addition, the highest power efficiency can be obtained only when wind blows in a predetermined direction due to a fixed-type wind indicator. In addition, the conventional system using the wind power has problems in that the wind direction is continuously changed, drag occurs in fluid at the speed of the fluid, an amount of air flowing to the blades in a predetermined condition is limited, and air resistances due to an angle of the blade cannot be removed. Therefore, an enough power efficiency cannot be guaranteed.

### DISCLOSURE

### Technical Problem

An apparatus for changing positions of the tail wings by operating a driving motor using a controller when wind speeds of more than a predetermined value measured by an anemometer occur for a predetermined time, is introduced. However, this operation requires power, and a structure for this operation is complex. In addition, due to problems of breakdowns and maintenances, the efficiency is decreased. To solve the problem as described above, the present invention provides an additional turbo air compressor system capable of improving a power efficiency in the same condition.

The present invention also provides the turbo air compressor system which is mounted to a front portion of an apparatus using wind power to compress flowing air and increase rotating force and can improve the power efficiency as compared with another system in the same condition.

The present invention also provides the turbo air compressor system which includes inclined portions at multistage plates to change a current of the flowing air, so that air resistances in contrary directions exerted by a rotor can be removed, the air current in a predetermined region can be transited to a vacuum stage, and the air resistances due to friction that occurs when the rotor rotates can be effectively improved.

### Technical Solution

To achieve the object as described above, the present invention provides a system using the turbo air compressor system capable of solving problems of a solar heat power generation system or a photovoltaic power generation system which is used instead of a conventional wind power system due to a low efficiency and is influenced by weather change, problems of inefficiencies of slow response to changes in the wind direct ion and unnecessary energy source consumption due to a direction changing method of a rotor electrically operating and using a sensor sensing the wind direction, problems in that the wind direction is continuously changed, drag occurs in fluid at the speed of the fluid, an amount of air flowing to the blades in a predetermined condition is limited, air resistances occur due to an angle of the blade, and an enough power efficiency cannot be guaranteed, and problems of inefficiency in consideration of costs and natural conditions, thereby obtaining a higher efficiency as compared with a conventional hybrid power generation system.

### Advantageous Effects

The system according to the present invention can be used to increase an amount of wind power as compared with a conventional wind power system in the same conditions. In addition, in an area with the low wind speed, a high power efficiency can be obtained. In addition, an installation space can be significantly reduced with the same efficiency and power capacity, so that economic installation against restrictions on regional and environmental influences can be easily performed. In addition, an environment-friendly fine view of the city can be considered, and an optimal power efficiency can be provided at the low wind speed. In addition, the tail wings have a plate-type structure, and advertisements can be attached thereto, so that the impact of the advertisements can be obtained.

### DESCRIPTION OF DRAWINGS

FIG. 1 is a perspective view illustrating the entire structure of a turbo air compressor system according to an embodiment of the present invention;

FIG. 2 is a perspective view illustrating a structure of a turbo air compressor system according to another embodiment of the present invention;

FIG. 3 is a perspective view illustrating a structure of a turbo air compressor system according to another embodiment of the present invention;

FIG. 4 is a perspective exploded view for explaining a process of assembling the turbo air compressor system according to the embodiment of the present invention;

FIG. 5 is a perspective exploded view for explaining the process of assembling the turbo air compressor system according to the embodiment of the present invention;

FIG. 6 is a perspective view for explaining the process of assembling the turbo air compressor system according to the embodiment of the present invention;

FIG. 7 is a view for explaining a process of fixing the turbo air compressor system according to the embodiment of the present invention;

FIG. 8 is a view for explaining the process of fixing the turbo air compressor system according to the embodiment of the present invention;

FIG. 9 is a perspective view illustrating an example of the turbo air compressor system according to the embodiment of the present invention;

FIG. 10 is a view illustrating an example of operations of the turbo air compressor system according to the embodiment of the present invention;

FIG. 11 is a three-dimensional view illustrating an example (front view) of the mounted turbo air compressor system according to the embodiment of the present invention; and

FIG. 12 is a three-dimensional view illustrating an example (rear view) of the mounted turbo air compressor system according to the embodiment of the present invention.

### BEST MODE

According to an aspect of the present invention, there is provided a turbo air compressor system used for a wind power system to control flowing air, including: a plurality of multistage plates 2 which are vertically disposed at predetermined intervals, and of which widths decrease in a direction of from a rear portion to a front portion; supporting plates 3 which are horizontally fixed to support top and bottom portions of a plurality of the multistage plates 2; reinforcement ribs 6 which are disposed between the upper and lower supporting plates 3 in parallel with the upper and lower supporting plates 3, are mounted to each multistage plate 2 at predetermined intervals, have a rear surface with the same length as a width of the multistage plate 2 contacting the rear surface of the reinforcement rib 6, and have a front surface with the same length as a width of the multistage plate 2 contacting the front surface of the reinforcement rib 6, so as to form front surface inclined portions 11; fixing members 7 which have a shape of a trigonal prism, are disposed at a surface adjacent to the multistage plate 2 to engage the reinforcement ribs 6 with the multistage plate 2, and have a surface and the other surface that are fixed to the multistage plate 2 and the reinforcement rib 6 by adhesives, respectively; air compression inlets 10 which are formed by assembling the multistage plates 2, the reinforcement ribs 6, and the supporting plates 3 so as to enable air to flow thereto; exhaust outlets 9 through which air flowing through the air compression inlets 10 are compressed to be passed; and a rounded portion 5 which is a rounded surface of the supporting plate to have a shape similar to a circular arc of a rotor so as to enable the cylinder-shaped rotor to be attached to the main body 1.

### MODE FOR INVENTION

Hereinafter, exemplary embodiments of the present invention will be described in detail with reference to the attached drawings.

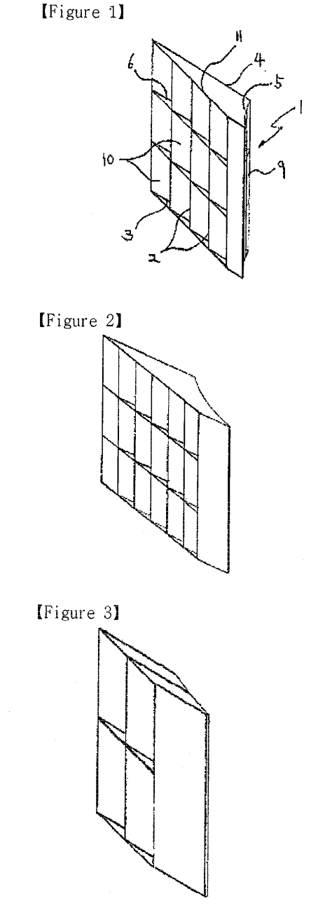

FIG. 1 is a perspective view illustrating the entire structure of a turbo air compressor system according to an embodiment of the present invention. A turbo air compressor system main body 1 includes a plurality of air compression inlets 10. The plurality of air compression inlets 10 are formed by engaging horizontal supporting plates 3 and vertical multistage plates 2.

FIGS. 2 and 3 are perspective views illustrating structures of a turbo air compressor system according to other embodiments of the present invention. Referring to FIGS. 2 and 3, the turbo air compressor system has multistage plates 2 engaged with supporting plates 3 and reinforcement ribs 6, and the number of multistage plates 2 is different from that illustrated in FIG. 1. FIG. 2 illustrates a 7-stage turbo air compressor system having seven engaged multistage plates 2, and FIG. 3 illustrates a 3-stage turbo air compressor system. As described above, the number of engaged multistage plates included in the main body 1 may be changed, so that various applications can be implemented according to rotors, blades, or changes in external environments such as the wind speed and the wind direction.

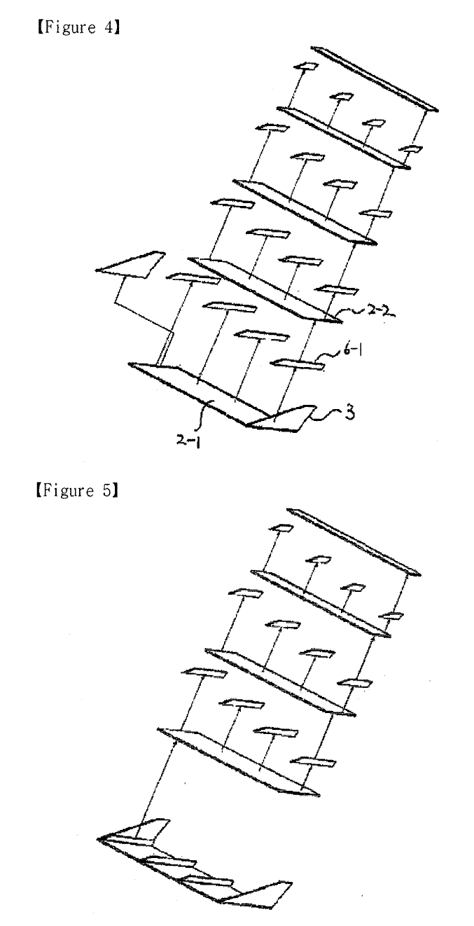

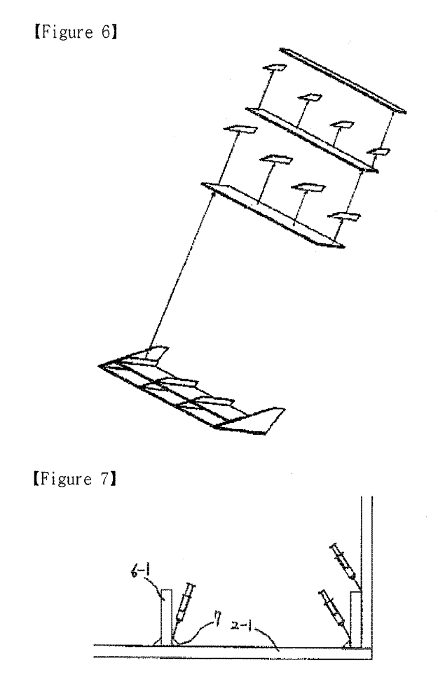

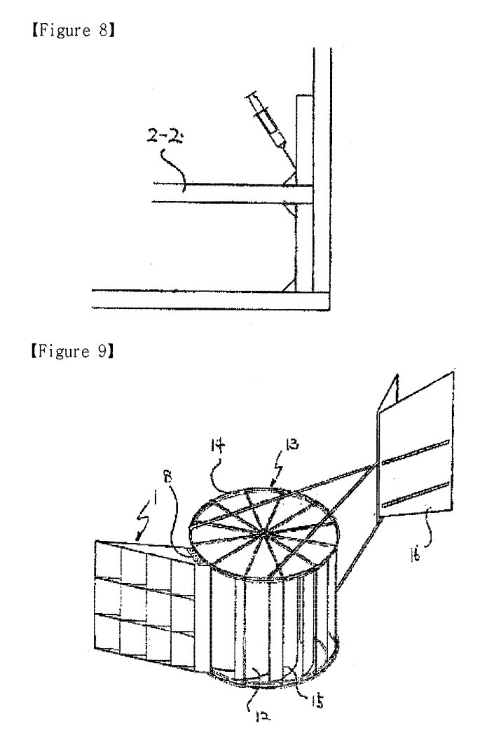

FIGS. 4 to 8 are views for explaining processes of assembling and fixing the turbo air compressor system according to the embodiment of the present invention. In the processes of assembling and fixing the turbo air compressor system according to the embodiment of the present invention, the supporting plates 3 are mounted to both sides of a first multistage plate 2-1, and first reinforcement ribs 6-1 are mounted to the first multistage plate 2-1 between the both supporting plates 3.

The first reinforcement rib 6-1 mounted to the first multistage plate 2-1 may be fixed by fixing members 7 having a shape of a trigonal prism and adhesives. Generally, the plates 2 and 3 may be made of polycarbonate. and the fixing member 7 may be made of acryl.

A second multistage plate 2-2 is fixed on the first reinforcement ribs 6-1 mounted to the first multistage plate 2-1, and the aforementioned operations are repeated to complete the main body 1.

FIG. 9 is a perspective view illustrating an example of the turbo air compressor system according to the embodiment of the present invention. The turbo air compressor system main body 1 is engaged and fixed to a rotor 12 or a circumference surface of a frame or housing 13 for protecting the rotor 12 by a bent fixing plate 8. Specifically, top and bottom portions of the horizontal supporting plate 3 are tightened with portions adjacent to a circular frame 14 formed at top and bottom portions of the housing 13 by the fixing plate 8 with a bolt or rivet for connection. Accordingly, a vertical length of the turbo air compressor system main body 1 may be the same as an interval between upper and lower circular frames 14 of the housing 13.

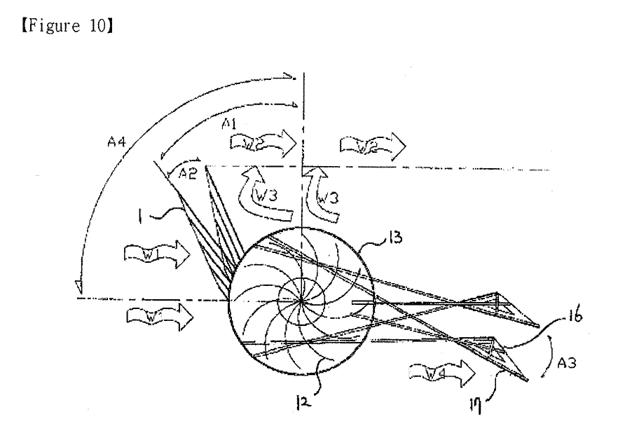

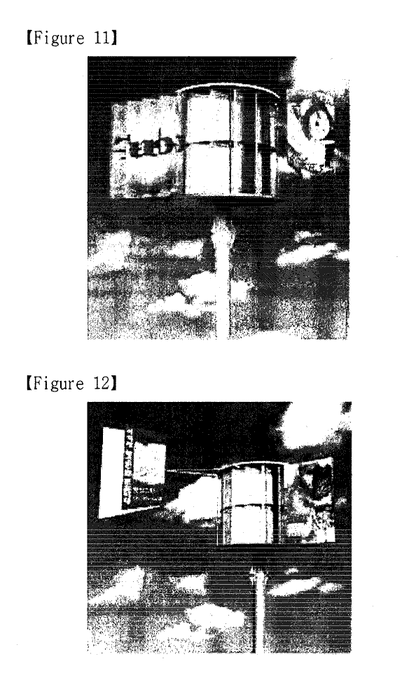

FIG. 10 is a view illustrating an example of operations of the turbo air compressor system according to the embodiment of the present invention. FIGS. 11 and 12 are three-dimensional views illustrating an example of the mounted turbo air compressor system according to the embodiment of the present invention. In order for the turbo air compressor system main body 1 to be securely tightened with a connect ion frame 15 of the cylinder-shaped housing 13 and the upper and lower circular frames 14, the turbo air compressor system main body 1 is provided with a rounded portion 5 that is to be attached to a surface adjacent to the housing 13.

The turbo air compressor system main body 1 is used to accelerate the rotation speed of the rotor 12 rotating in the wind direction at the wind speed for wind power. When it is assumed that wind blows on the cylinder-shaped rotor 12 in a direction and the main body 1 is not mounted, forces in the contrary direction (clockwise) is exerted on a portion A4 of a front surface of the blade (rotor) facing air flowing to the rotor 12. In order to compensate for this, the main body 1 is mounted at such a position that the portion where resistances in the contrary direction are exerted can be covered. In addition, the flowing air turns counterclockwise along a front surface inclined portion 11, and flows through the air compression inlet 10 to an exhaust outlet 9. In this case, a cross-section of the compression inlet 10 is inclined to be larger than that of the exhaust outlet 9, so that the speed of the air flowing through the exhaust outlet 9 is higher than the speed of the air flowing through the compression inlet 10, and thus the rotor 12 can rotate at a faster speed.

In addition, the main body 1 may have a length A5 lager than that of the rotor 12 in order to increase the air inflow. Moreover. in addition to the increase in the flowing air, when wind blows in a direction W2 of the front surface, a vacuum space is formed, and the direction of the flowing air is changed to a direction W3 in the vacuum space, so that an advantage of rotating the rotor counterclockwise is additionally obtained.

The turbo air compressor system facing the wind direction internally compresses the continuously blowing wind, and the external main body 1 is pushed clockwise. Here, due to continuous differences in time of the blowing wind, the wind flows to a main wing-side front surface 17 of the tail wing 16. In addition, the turbo main body 1 moves counterclockwise by air resistances of the tail wing to its former position to maintain a balance, and the compressed wind blows to the blade of the rotor 12 to increase the rotating force.

In addition, since a density of the air increases when the air continuously flows to the air compression inlet 10 of the turbo air compressor system, a compression ratio of the air increases, and pressure thereof increases. In addition, a rear surface inclined portion 4 of the turbo air compressor system main body 1 is formed to be longer than the rotor 12 to serve as nonresistance so that the resistance of the wind at a particular area becomes zero. This forms an interval where vacuum occurs according to a size or a mounted angle of the main body 1. Accordingly, blades in the opposite side of the wind can rotate, so that light wind power is possible, and the main body 1 can be adjusted to the wind blowing everywhere through 360°.

In addition, an advertisement or an image can be displayed on the multistage plate 2 disposed at the front surface of the turbo air compressor system by applying paint or coating, so that the impact of advertisements can be obtained as illustrated in FIGS. 7A and 7B.

In addition, the turbo air compressor system is organically operated with the tail wings 16. Therefore, when the main body 1 is moved to a predetermined range A2 by the wind direction W1, the tail wings are relatively moved to a range A3, and in this case, wind resistances are exerted on the main wing-side front surface 17 so that the main body 1 can be returned to its original position. The predetermined range may be designed to range from 27 Degree to 70 Degree

### INDUSTRIAL APPLICABILITY

The system according to the present invention can be used to increase an amount of wind power as compared with a conventional wind power system in the same conditions. In addition, in an area with the low wind speed, a high power efficiency can be obtained. In addition, an installation space can be significantly reduced with the same efficiency and power capacity, so that economic installation against restrictions on regional and environmental influences can be easily performed. In addition, an environment-friendly fine view of the city can be considered, and an optimal power efficiency can be provided at the low wind speed. In addition, the tail wings have a plate-type structure, and advertisements can be attached thereto, so that the impact of the advertisements can be obtained.

1. A turbo air compressor system used for a wind power system to control flowing air, comprising:
a plurality of multistage plates 2 which are vertically disposed at predetermined intervals, and of which widths decrease in a direction of from a rear portion to a front portion;
supporting plates 3 which are horizontally fixed to support top and bottom portions of a plurality of the multistage plates 2;
reinforcement ribs 6 which are disposed between the upper and power supporting plates 3 in parallel with the upper and power supporting plates 3, are mounted to each multistage plate 2 at predetermined intervals, have a rear surface with the same length as a width of the multistage plate 2 contacting the rear surface of the reinforcement rib 6, and have a front surface with the same length as a width of the multistage plate 2 contacting the front surface of the reinforcement rib 6, so as to form front surface inclined portions 11;
fixing members 7 which have a shape of a trigonal prism, are disposed at a surface adjacent to the multistage plate 2 to engage the reinforcement ribs 6 with the multistage plate 2, and have a surface and the other surface that are fixed to the multistage plate 2 and the reinforcement rib 6 by adhesives, respectively;
air compression inlets 10 which are formed by assembling the multistage plates 2, the reinforcement ribs 6, and the supporting plates 3 so as to enable air to flow thereto;
exhaust outlets 9 through which air flowing through the air compression inlets 10 are compressed to be passed; and
a rounded portion 5 which is a rounded surface of the supporting plate to have a shape similar to a circular arc of a rotor so as to enable the cylinder-shaped rotor to be attached to the main body 1.

2. The system of claim 1, wherein the number of the multistage plates assembled with the supporting plates and the reinforcement ribs is equal to or more than 3.

3. The system of claim 1, wherein advertisements are displayed on a front surface of the multistage plate of the main body by applying paint or coating.
